(19) United States
(12) Patent Application Publication
(10) Pub. No.: US 2017/0312754 A1
(43) Pub. Date: Nov. 2, 2017

(54) CRUSHING APPARATUS

(71) Applicant: Food Industry Research and Development Institute, Hsinchu City (TW)

(72) Inventors: Bao-Hung HUANG, Hsinchu City (TW); Lin-Shyang TZENG, Hsinchu City (TW); Chung-Jen CHEN, Hsinchu City (TW); Yi-Chieh TSAI, Hsinchu City (TW); Jyh HSIEH, Hsinchu City (TW); Chun Che HSIEH, Hsinchu City (TW)

(73) Assignee: Food Industry Research and Development Institute

(21) Appl. No.: 15/141,877

(22) Filed: Apr. 29, 2016

(51) Int. Cl. B02C 23/10; B02C 13/14; B02C 13/286; B04C 5/00; B02C 23/30

(52) U.S. Cl. CPC B02C 23/10; B04C 5/00; B02C 23/30; B02C 13/14; B02C 13/286; B02C 2013/28609

(57) ABSTRACT

A crushing apparatus includes a tank including a first aperture and a second aperture, a first blower around the first aperture, a grinder disposed within the tank, a separating device including a first hole connected to the second aperture, and a second hole, and a second blower disposed around the second hole.

### TECHNICAL FIELD

The present disclosure relates to a crushing apparatus, particularly an apparatus for grinding a material, and more particularly an appliance for crushing a material into powder or fine pieces.

### BACKGROUND

With an advancement of food processing technology, various kinds of machines are used for food processing. Some types of food materials are required to undergo processing by the machine before becoming edible for human. Upon the processing, the food material would be crushed into powder by the machine such as a grinder in order to be edible for human.

Since some kinds of food materials are light in weight and have high adhesiveness, these food materials easily flow out of the machine or block the machine during crushing. The crushing of the food materials would be unstable and the food materials could not be prepared as desired. Thus, there is a continuous need to modify the machine and the processing in order to overcome associated problems.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

One aspect of the present disclosure provides a crushing apparatus includes a tank including a first aperture and a second aperture, a first blower around the first aperture, a grinder disposed within the tank, a separating device including a first hole connected to the second aperture, and a second hole, and a second blower disposed around the second hole,

Another aspect of the present disclosure provides a crushing apparatus includes a crushing apparatus includes a tank including an opening, a bottom surface, a sidewall, and a first outlet disposed at the sidewall, a covering member disposed over the opening of the tank and including a first inlet perforated through the covering member, a passage connected with the first inlet, a first blower disposed around the first inlet, a grinder disposed within the tank and including a crushing element moveable relative to the tank, a separating device including a second inlet connected with the first outlet, and a second outlet, a sieve disposed between the first outlet and the second inlet, and a second blower disposed around the second outlet, wherein the passage is tilted relative to the covering member.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic cross sectional view of a crushing apparatus in accordance with some embodiments of the present disclosure.

FIG. 2 is a top cross sectional view of a tank of the crushing apparatus of FIG. 1

FIG. 3 is a schematic cross sectional view of a crushing apparatus in accordance with some embodiments of the present disclosure.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a crushing apparatus for grinding a material into powder. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

Upon grinding process, a material is delivered into a crushing tank continuously, and the material is then crushed into powder or fine pieces by a crushing element inside the crushing tank. During crushing, the material collides with the crushing element or a sidewall of the crushing tank, while an air is mixed with the material. After the crushing, the crushed material in powder state is conveyed to a separator for separating the crushed material from the air. The crushed material would then be discharged from the separator and collected by a container or a bag.

However, the material delivered into the crushing tank is light in weight. As such, the material would be easily resiled and flowed out of the crushing tank, and thus the delivery of the material is hindered and becomes unstable. Furthermore, the adhesiveness of the material would be increased after the crushing. The crushed material with high adhesiveness would be easily adhered to a sidewall of the separator. As a result, some of the crushed material could not be smoothly discharged from the separator and could not be collected effectively. In addition, the material is delivered from the crushing tank to the separator across a sieve disposed between the crushing tank and the separator. Since the material easily adheres to the sieve, the material would accumulate on the sieve or even would completely block the sieve after a period of time. As such, the material could not pass through the sieve and could not be delivered from the crushing tank to the separator.

In the present disclosure, a crushing apparatus with improved configuration is disclosed. The crushing apparatus includes a tank, a first blower disposed at an inlet of the tank, a grinder with a crushing element inside the tank, a separating device connected with the tank, and a second blower disposed adjacent to an outlet of the separating device. The first blower can urge a delivery of a material into the tank, and thus the material would not flow out of the tank and could be smoothly delivered into the tank. The crushing element is configured to direct an airflow from the first blower towards an outlet or a sidewall of the tank, such that the material crushed by the grinder can be effectively delivered from the tank into the separating device. The second blower provides an airflow in a direction opposite to the flowing of the crushed material inside the separating device, such that the crushed material would not adhere to a sidewall of the separating device and could be discharged from the separating device effectively.

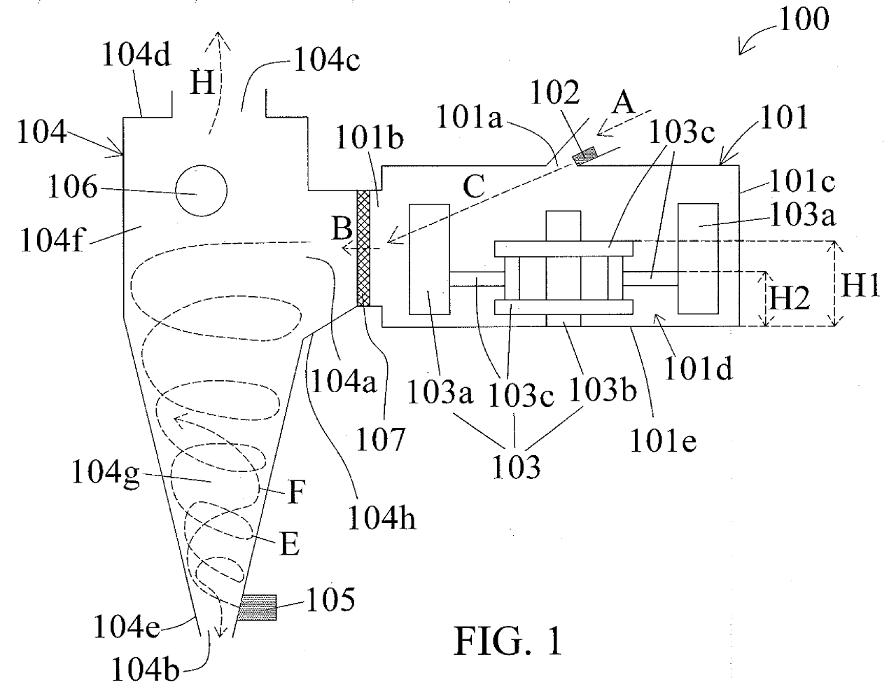

FIG. 1 is a schematic cross sectional view of a crushing apparatus 100 in accordance with some embodiments of the present disclosure. In some embodiments, the crushing apparatus 100 includes a tank 101, a first blower 102, a grinder 103, a separating device 104 and a second blower 105.

In some embodiments, the crushing apparatus 100 is configured to grind or crush a material into powder or fine pieces and collect the powder. In some embodiments, the crushing apparatus 100 can be used for grinding the material such as food, herbs, fungus (e.g. Phellinus), Chinese medicine, etc. In some embodiments, the material is a fiber containing material. In some embodiments, the material includes more than one kind of ingredients or materials. In some embodiments, the material is a composite. In some embodiments, the material is light in weight (e.g. in powder state or in small pieces). In some embodiments, the material has high adhesiveness, that the material is easily adhered on a surface upon or after grinding. In some embodiments, the material has a size of greater than about 200 um before grinding.

In some embodiments, the tank 101 includes a first aperture 101a, a second aperture 101b, a sidewall 101c, a cavity 101d and a bottom surface 101e. In some embodiments, the tank 101 is configured to hold or temporarily storing the material. In some embodiments, the cavity 101d is defined by the sidewall 101c. In some embodiments, the cavity 101d holds or temporarily stores the material. In some embodiments, the sidewall 101c includes a roughened portion for assisting the grinding of the material. In some embodiments, the roughened portion of the sidewall 101c faces to an interior of the tank 101. In some embodiments, the tank 101 includes material non-corrosive or resistant to air or moisture. In some embodiments, the tank 101 includes metal such as aluminum, iron, stainless steel, etc.

In some embodiments, the first aperture 101a of the tank 101 is a first inlet. In some embodiments, the first aperture 101a is configured to deliver the material into the tank 101. In some embodiments, the first aperture 101a intakes the material into the cavity 101d of the tank 101. In some embodiments, the material is delivered into the tank 101 along a flowing direction A and passes through the first aperture 101a. In some embodiments, the first aperture 101a is a hole or a passage. In some embodiments, the first aperture 101a is disposed at a top portion or an upper portion of the tank 101. In some embodiments, a funnel is connected with the first aperture 101a. In some embodiments, the funnel is configured to hold or convey the material to be ground into the tank 101 through the first aperture 101a.

In some embodiments, the second aperture 101b is a first outlet. In some embodiments, the second aperture 101b is configured to discharge the material out of the tank 101. In some embodiments, the second aperture 101b conveying the material from the cavity 101d of the tank 101 to the separating device 104. In some embodiments, the material is delivered from the tank 101 to the separating device 104 along a flowing direction B and passes through the second aperture 101b. In some embodiments, the second aperture 101b is a hole or a passage. In some embodiments, the second aperture 101b is disposed at the sidewall 101c of the tank 101.

In some embodiments, the first blower 102 is disposed around or at the first aperture 101a. In some embodiments, the first blower 102 is configured to blow out an air or generate an airflow in a predetermined direction. In some embodiments, the first blower 102 points towards the second aperture 101b of the sidewall 101c of the tank 101. In some embodiments, the first blower 102 generates an airflow travelling from the first blower 102 towards the second aperture 101b or the sidewall 101c of the tank 101. In some embodiments, the first blower 102 generates an airflow in a flowing direction C. In some embodiments, the flowing direction C is tilted in an angle relative to the bottom surface 101e of the tank 101. In some embodiments, the angle between the flowing direction C and the bottom surface 101e is about 10° to 50°. In some embodiments, the angle is about 30°.

In some embodiments, the first blower 102 is a nozzle. In some embodiments, the first blower 102 generates an airflow in an air pressure of about 0.01 MPa to about 0.2 MPa. In some embodiments, an air adjacent to or at the first aperture 101a is accelerated by the first blower 102, and as such an air pressure at or adjacent to the first aperture 101a becomes lower than an air pressure outside the tank 101, and as a result the material would be sucked into the tank 101 through the first aperture 101a due to the air pressure difference. The material would be drawn from a relatively high air pressure to a relatively low air pressure. As such, the material would be forced to enter the tank 101 through the first aperture 101a. Therefore, the material would not be flowed out from the tank 101 through the first aperture 101a. The material can be delivered into the tank 101 smoothly, steadily and continuously. In some embodiments, the material delivers into the tank 101 is a speed of about 2 gram/minute to about 60 gram/minute.

In some embodiments, the grinder 103 is disposed within the tank 101. In some embodiments, the grinder 103 is installed inside the tank 101 in order to grind the material inside the cavity 101d into powder. In some embodiments, the grinder 103 is disposed at a center of the tank 101. In some embodiments, the grinder 103 is surrounded by the sidewall 101c of the tank 101. In some embodiments, the grinder 103 includes several rotatable components configured to collide with the material in order to grind the material into powder. In some embodiments, the grinder 103 is configured to provide a force on the material, such that the material is cut, crushed or divided into fine pieces or powder. In some embodiments, the grinder 103 is configured to provide a friction on the material for grinding or crushing the material into powder. In some embodiments, the grinder 103 includes material non-corrosive or resistant to air or moisture. In some embodiments, the grinder 103 includes metal such as aluminum, iron, stainless steel, etc.

In some embodiments, the grinder 103 includes a crushing element 103a, a shaft 103b and a connecting member 103c. In some embodiments, the shaft 103b is protruded from the bottom surface 101e of the tank 101. In some embodiments, the shaft 103b stands upright and is substantially orthogonal to the bottom surface 101e. In some embodiments, the connecting member 103c connects the shaft 103b and the crushing element 103a. In some embodiments, the connecting member 103c extends between the shaft 103b and the crushing element 103a.

In some embodiments, the connecting member 103c is disposed away from the bottom surface 101e, such that the connecting member 103c would not block or interrupt the airflow from the first blower 101 or the airflow in the flowing direction C. In some embodiments, the connecting member 103c is disposed away from the bottom surface 101e of the tank 101 in a vertical distance (H1 or H2) of less than about 45 mm. In some embodiments, the vertical distance (H1 or H2) is about 40 mm to about 55 mm. In some embodiments, the vertical distance (H1 or H2) is about 30 mm to about 45 mm.

In some embodiments, the crushing element 103a is configured to grind the material. In some embodiments, the crushing element 103a is movable relative to the tank 101. In some embodiments, the crushing element 103a is rotatable about the shaft 103b. In some embodiments, the material can be ground into powder when the crushing element 103a is rotated about the shaft 103b. In some embodiments, the material can be ground into powder by cooperation of the crushing element 103a and the roughened portion of the sidewall 101c. The crushing element 103a and the roughened portion of the sidewall 101c are configured to grind the material cooperatively. In some embodiments, the crushing element 103a provides a first force on the material and the roughened portion of the sidewall 101c provides a second force on the material in a direction opposite to the first force, such that the material would be ground or crushed into fine pieces or powder by the first force and the second force. In some embodiments, the grinder 103 includes more than one crushing element 103a or a pair of the crushing elements 103a disposed opposite to each other.

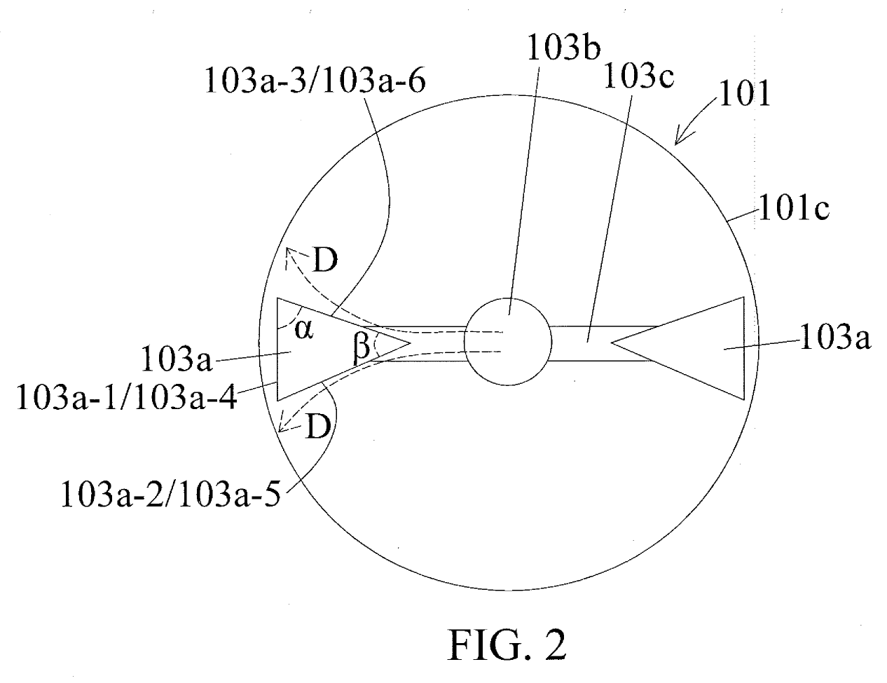

FIG. 2 is a top cross sectional view of the tank 101 and the grinder 103. In some embodiments, the crushing element 103a is in a tapered configuration. In some embodiments, the crushing element 103a is tapered from the sidewall 101c of the tank 101 towards the shaft 103b. In some embodiments, the crushing element 103a includes a surface (103a-2 or 103a-3) configured to direct an airflow travelling towards the second aperture 101b or the sidewall 101c of the tank 101. In some embodiments, the surface (103a-2 or 103a-3) is configured to direct an airflow in a flowing direction D. In some embodiments, the crushing element 103a is configured to direct the material travelling towards the second aperture 101b or the separating device 104. In some embodiments, the crushing element 103a would not block or interrupt the airflow from the first blower 101, the airflow in the flowing direction C or the airflow in the flowing direction D. In some embodiments, a surface 130a-1 is disposed adjacent to the second aperture 101b or the sidewall 101c of the tank 101.

In some embodiments, a cross section of the crushing element 103a is in a triangular shape. In some embodiments, the cross section of the crushing element 103a includes a first side 103a-4, a second side 103a-5, a third side 103a-6, an interior angle α between the first side 103a-4 and the third side 103a-6, and an interior angle β between the second side 103a-5 and the third side 103a-6. In some embodiments, the interior angle α or the interior angle β is about 20° to about 60°. In some embodiments, the interior angle β is about 30° to about 50°. In some embodiments, the interior angle α is about 50° to about 60°. In some embodiments, the interior angle β is substantially smaller than the interior angle α. In some embodiments, the first side 103a-4 is substantially shorter than the second side 103a-5 or the third side 103a-6. In some embodiments, a length of the first side 103a-4 is shorter than a length of the second side 103a-5 or a length of the third side 103a-6. In some embodiments, the length of the second side 103a-5 is substantially same as the length of the third side 103a-6.

In some embodiments, the separating device 104 is configured to separate the material ground by the grinder 103 or the material in powder state from air. Upon crushing, the material is mixed with air. As such, the separating device 104 is required for separating the material ground by the grinder 103 from the air. In some embodiments, the material and the air are separated by cyclonic separation.

In some embodiments, the separating device 104 is elongated from a first end 104d to the second end 104e opposite to the first end 104d. In some embodiments, the separating device 104 is in a cylindrical or tubular configuration. In some embodiments, the separating device 104 is extended vertically. In some embodiments, the separating device 104 includes a cylindrical portion 104f and a conical portion 104g coupled with the cylindrical portion 104f. In some embodiments, the conical portion 104g is tapered away from the cylindrical portion 104f or the first end 104d. In some embodiments, the cylindrical portion 104f has a width greater than a width of the conical portion 104g.

In some embodiments, the separating device 104 includes a first hole 104a and a second hole 104b. In some embodiments, the first hole 104a is a second inlet. In some embodiments, the second hole 104b is a second outlet. In some embodiments, the first hole 104a is configured to deliver the material ground by the grinder from the tank 101 into the separating device 104. In some embodiments, the second hole 104b is configured to discharge the material out of the separating device 104. In some embodiments, the first hole 104a is in a rectangular, quadrilateral or square shape. In some embodiments, a sidewall 104h of the first hole 104a is a sloped sidewall. In some embodiments, the sidewall 104h of the first hole 104a is inclined from the separating device 104 towards the tank 101. Such configuration of the sidewall 104h of the first hole 104a can prevent the material from adhering to or accumulating at the first hole 104a or the sidewall 104h. The material can pass through the first hole 104a and deliver from the tank 101 to the separating device 104 smoothly.

In some embodiments, the material ground by the grinder 103 is discharged from the second aperture 101b and then entered the separating device 104 through the first hole 104a along the flowing direction B. In some embodiments, the first hole 104a connects with the second aperture 101b of the tank 101. In some embodiments, the first hole 104a is configured to deliver the material from the tank 101 into the separating device 104. In some embodiments, the material ground by the grinder 103 would be forced by an air to flow from the tank 101 to the separating device 104. In some embodiments, the material would be moved by the air, such that the material would flow compulsorily from the tank 101 to the separating device 104.

In some embodiments, the first hole 104a is disposed at the cylindrical portion 104f of the separating device 104. In some embodiments, the first hole 104a is disposed adjacent to the first end 104d of the separating device 104. In some embodiments, the first hole 104a is disposed at an upper portion of the separating device 104. In some embodiments, the second hole 104b is configured to discharge the material out of the separating device 104. In some embodiments, the second hole 104b is disposed at the conical portion 104g of the separating device 104. In some embodiments, the second hole 104b is disposed adjacent to the second end 104e of the separating device 104. In some embodiments, the second hole 104b is disposed at a lower portion of the separating device 104.

In some embodiments, the separating device 104 is a cyclone configured to generate a first airflow travelling from the first hole 104a towards the second hole 104b and separate the material from the air. In some embodiments, the separating device 104 includes a third hole 104c configured to discharge the air separated from the material. As such, the air would be discharged from the third hole 104c out of the separating device 104 along a flowing direction H, and the material ground by the grinder 103 would travel from the first hole 104a to the second hole 104b by the first airflow or along the flowing direction E. In some embodiments, the first airflow includes a helical airflow. In some embodiments, the material would be discharged from the second hole 104b out of the separating device 104 along the flowing direction E. In some embodiments, the material ground by the grinder 103 can be collected at the second hole 104b. Since the material can flow smoothly and continuously from the first aperture 101a to the second aperture 101b, the size of each pieces of the material ground by the grinder 103 are substantially same as each other, and the material can enter the crushing apparatus 100 as well as discharge out of the crushing apparatus 100 steadily.

In some embodiments, a sieve 107 is disposed between the second aperture 101b and the first hole 104a. In some embodiments, the sieve 107 is perforated and includes several perforations in a predetermined size. In some embodiments, the perforations of the sieve 107 are sized such that only the material ground by the grinder 103 can pass through the sieve 107 and discharge from the tank 101 to the separating device 104. In some embodiments, the size of the perforation of the sieve 107 is slightly greater than or same as a predetermined size of the material ground by the grinder 103. In some embodiments, the predetermined size of the material ground by the grinder 103 is about 15 um to about 400 um. In some embodiments, the perforation of the sieve 107 is about 20 um to about 500 um. In some embodiments, the sieve 107 is a mesh wire. In some embodiments, the sieve 107 includes metal, plastics, etc.

In some embodiments, the material ground by the grinder 103 travels across the sieve 107 along the flowing direction B. The material ground by the grinder 103 would be moved by an air, such that the material would flow compulsorily across the sieve 107. In some embodiments, the first blower 102 points towards the sieve 107. In some embodiments, the first blower 102 is configured to generate an airflow travelling from the first blower 102 towards the sieve 107 along the flowing direction C. In some embodiments, the surface (103a-2 or 103a-3) of the crushing element 103a is configured to direct an airflow travelling towards the sieve 107 along the flowing direction D. As such, the first blower 102 can promote the material ground by the grinder 103 travelling across the sieve 107, and thus the material adhering on the sieve 107 during travelling from the second aperture 101b to the first hole 104a can be prevented or minimized. The material can travel across the sieve 107 smoothly and continuously.

In some embodiments, the second blower 105 is disposed around or at the second hole 104b of the separating device 104. In some embodiments, the second blower 105 is disposed at the conical portion 104g of the separating device 104. In some embodiments, the second blower 105 is disposed at the second end 104e of the separating device 104. In some embodiments, the second blower 105 is disposed at the lower portion of the separating device 104. In some embodiments, the second blower 105 is a nozzle.

In some embodiments, the second blower 105 is configured to blow out an air or generate an airflow in a predetermined direction. In some embodiments, the second blower 105 points towards the second hole 104b or an interior sidewall of the separating device 104. In some embodiments, the second blower 105 is configured to generate an airflow travelling from the second end 104e towards the first end 104d of the separating device 104. In some embodiments, the second blower 105 is configured to generate an airflow travelling from the conical portion 104g towards the cylindrical portion 104f of the separating device 104. In some embodiments, the second blower 105 is configured to generate a second airflow travelling opposite to the first airflow. In some embodiments, the second blower 105 generates an airflow in a flowing direction F opposite to the flowing direction E. Since the second airflow is in a direction opposite to the first airflow, the material inside the separating device 104 would not be adhered to the interior sidewall of the separating device 104, and thus the material can be flowed and discharged from the second hole 104b smoothly and steadily. In some embodiments, the second blower 105 is turned on and off periodically, or the airflow in the flowing direction F is generated periodically. In some embodiments, the second blower 105 is turned on for a certain period of time, and then turned off for another certain period of time. The second blower 105 is turned on and off alternately and repeatedly. In some embodiments, the second blower 105 is turned on for about 1 second to about 3 seconds, and then turned off for about 5 seconds to about 25 seconds. In some embodiments, the airflow in the flowing direction F or the airflow generated by the second blower 105 has an air pressure of about 0.005 MPa to about 0.1 MPa.

In some embodiments, a vibrating device 106 is attached on the separating device 104. In some embodiments, the vibrating device 106 is attached on an outer surface of the separating device 104. In some embodiments, the vibrating device 106 is attached on the cylindrical portion 104f of the separating device 104. In some embodiments, the vibrating device 106 is configured to oscillate the separating device 104 in a predetermined frequency. In some embodiments, the separating device 104 is configured to promote the material travelling from the first hole 104a to the second hole 104b and thus prevent or minimize the material adhering on the interior sidewall of the separating device 104 upon travelling from the first hole 104a to the second hole 104b.

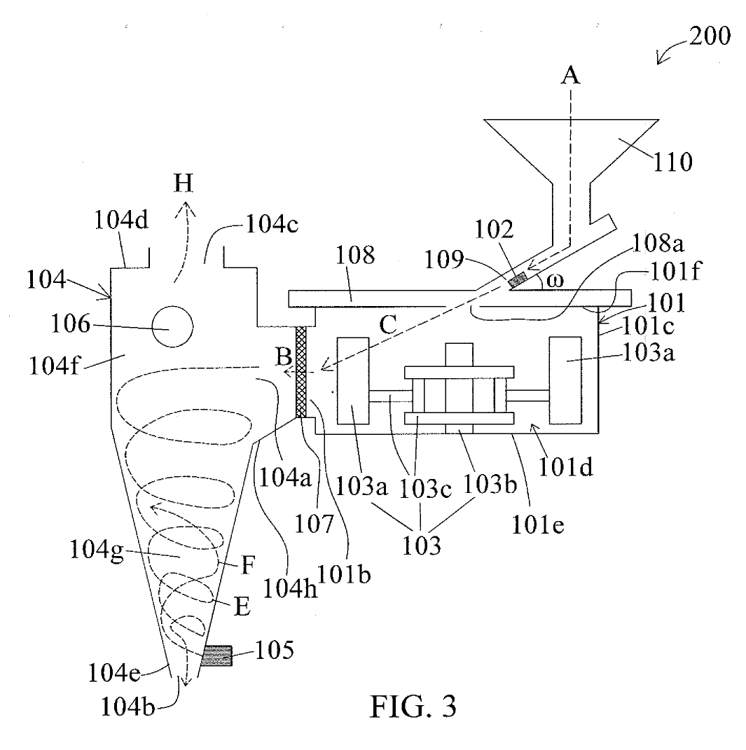

FIG. 3 is a schematic cross sectional view of a crushing apparatus 200 in accordance with some embodiments of the present disclosure. In some embodiments, the crushing apparatus 200 includes a tank 101, a first blower 102, a grinder 103, a separating device 104, a second blower 105, a vibrating device 106 and a sieve 107, which have similar configurations as described above or illustrated in FIGS. 1 and 2. In some embodiments, the crushing apparatus 200 includes a covering member 108, a passage 109 and a funnel 110.

In some embodiments, the covering member 108 is disposed over the tank 101. In some embodiments, the covering member 108 covers an opening 101f of the tank 101. In some embodiments, the covering member 108 is disposed over the opening 101f of the tank 101. In some embodiments, the covering member 108 includes an inlet 108a perforated through the covering member 108. In some embodiments, the tank 101 is accessible through the inlet 108a. In some embodiments, the first blower 102 is disposed around or at the inlet 108a. In some embodiments, the first blower 102 is disposed between the covering member 108 and the passage 109. In some embodiments, the covering member 108 includes metal such as aluminum, iron, stainless steel, etc.

In some embodiments, the passage 109 connects with the inlet 108a. In some embodiments, the passage 109 is disposed over the covering member 108. In some embodiments, the passage 109 is tilted relative to the covering member 108. In some embodiments, the passage 109 is titled relative to the covering member 108 in an angle ω. In some embodiments, the angle ω is an acute angle, an obtuse angle or an angle between about 10° to about 75°. In some embodiments, the angle ω is about 20° to about 55°. Since the passage 109 is tilted relative to the covering member 108, the material can be directed towards the sidewall 101c of the tank 101 and delivered into the tank 101 along the flowing direction C. As such, the material would not directly strike on the bottom surface 101e of the tank 101 upon entering the tank 101 and thus the material would not easily flow out of the tank 101 upon entering the tank 101. The material would enter the tank 101 smoothly and steadily.

In some embodiments, the passage 109 points towards the second aperture 101b or the sieve 107. In some embodiments, the passage 109 is in a cylindrical or tubular shape. In some embodiments, the passage 109 includes metal such as aluminum, iron, stainless steel, etc. In some embodiments, the covering member 108 is integral with the passage 109.

In some embodiments, the funnel 110 is disposed over the covering member 108 and the passage 109. In some embodiments, the funnel 110 connects with the passage 109. In some embodiments, the funnel 110 is configured to temporarily hold a material and conveying the material into the tank 101 through the opening 101f. In some embodiments, the material can deliver from the funnel 110 into the tank 101 through the passage 109 and the covering member 108. In some embodiments, the material can flow from the funnel 110 into the tank 101 along the flowing direction A and the flowing direction C. In some embodiments, the covering member 108, the passage 109 and the funnel 110 are integrally formed.

In some embodiments, a crushing apparatus includes a tank including a first aperture and a second aperture, a first blower around the first aperture, a grinder disposed within the tank, a separating device including a first hole connected to the second aperture, and a second hole, and a second blower disposed around the second hole.

In some embodiments, the first blower points towards the second aperture. In some embodiments, the separating device includes a cylindrical portion and a conical portion coupled with and tapered away from the cylindrical portion, the first hole is disposed at the cylindrical portion, the second hole and the second blower are disposed at the conical portion. In some embodiments, the separating device is configured to generate a first airflow travelling from the first hole towards the second hole, and the second blower is configured to generate a second airflow travelling opposite to the first airflow. In some embodiments, the grinder includes a crushing element in a tapered configuration. In some embodiments, the separating device is a cyclone. In some embodiments, the crushing apparatus further includes a vibrating device attached on the separating device.

In some embodiments, a crushing apparatus, comprising: a tank including an opening, a bottom surface, a sidewall, and a first outlet disposed at the sidewall, a covering member disposed over the opening of the tank and including a first inlet perforated through the covering member, a passage connected with the first inlet, a first blower disposed around the first inlet, a grinder disposed within the tank and including a crushing element moveable relative to the tank, a separating device including a second inlet connected with the first outlet, and a second outlet, a sieve disposed between the first outlet and the second inlet; and a second blower disposed around the second outlet, wherein the passage is tilted relative to the covering member.

In some embodiments, the first blower points towards the sieve. In some embodiments, the passage is tilted relative to the covering member in an acute angle, an obtuse angle or an angle between about 10° to about 75°. In some embodiments, a cross section of the crushing element includes a first side, a second side and an interior angle between the first side and the second side, and the interior angle is about 30° to about 60° In some embodiments, a cross section of the crushing element includes a first side, a second side, a third side, a first interior angle between the first side and the third side, and a second interior angle between the second side and the third side, the second interior angle is substantially smaller than the first interior angle. In some embodiments, the first interior angle is about 50° to about 60°, the second interior angle is about 30° to about 50°. In some embodiments, a cross section of the crushing element is in a triangular shape. In some embodiments, a cross section of the crushing element includes a first side, a second side and a third side, the first side is substantially shorter than the second side or the third side. In some embodiments, the second side has substantially same length as the third side. In some embodiments, the crushing element includes a surface configured to direct an airflow travelling towards the first outlet, the sieve or the sidewall of the tank. In some embodiments, the grinder includes a shaft protruded from the bottom surface of the tank and a connecting member connecting the shaft and the crushing element, the connecting member is disposed away from the bottom surface of the tank in a vertical distance of less than about 45 mm. In some embodiments, the crushing element is tapered from the sidewall of the tank towards the shaft.

In some embodiments, a crushing apparatus includes a tank including a first aperture, a sidewall, a second aperture disposed over the sidewall, and a bottom surface, a first blower disposed around the first aperture, and a grinder surrounded by the sidewall of the tank and including a shaft protruded from the bottom surface of the tank, a crushing element rotatable about the shaft and configured to grind a material, and a connecting member extending between the shaft and the crushing element, wherein the crushing element includes a surface extending between the connecting member and the sidewall of the tank, substantially orthogonal to the bottom surface of the tank, and configured to direct the material towards the second aperture.

In some embodiments, the crushing apparatus further includes a funnel connected with the passage. In some embodiments, the sidewall of the tank includes a roughened portion, the crushing element and the roughened portion of the sidewall are cooperatively operable with each other.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A crushing apparatus, comprising:
a tank including a first aperture and a second aperture;
a first blower disposed around the first aperture;
a grinder disposed within the tank;
a separating device including a first hole connected to the second aperture, and a second hole; and
a second blower disposed around the second hole.

2. The crushing apparatus of claim 1, wherein the first blower points towards the second aperture.

3. The crushing apparatus of claim 1, wherein the separating device includes a cylindrical portion and a conical portion coupled with is and tapered away from the cylindrical portion, the first hole is disposed at the cylindrical portion, the second hole and the second blower are disposed at the conical portion.

4. The crushing apparatus of claim 1, wherein the separating device is configured to generate a first airflow travelling from the first hole towards the second hole, and the second blower is configured to generate a second airflow travelling opposite to the first airflow.

5. The crushing apparatus of claim 1, wherein the grinder includes a crushing element in a tapered configuration.

6. The crushing apparatus of claim 1, wherein the separating device is a cyclone.

7. The crushing apparatus of claim 1, further comprising a vibrating device attached on the separating device.

8. A crushing apparatus, comprising:
a tank including an opening, a bottom surface, a sidewall, and a first outlet disposed at the sidewall;
a covering member disposed over the opening of the tank and including a first inlet perforated through the covering member;
a passage connected with the first inlet;
a first blower disposed around the first inlet;
a grinder disposed within the tank and including a crushing element moveable relative to the tank;
a separating device including a second inlet connected with the first outlet, and a second outlet;
a sieve disposed between the first outlet and the second inlet; and
a second blower disposed around the second outlet,
wherein the passage is tilted relative to the covering member.

9. The crushing apparatus of claim 8, wherein the first blower points towards the sieve.

10. The crushing apparatus of claim 8, wherein the passage is tilted relative to the covering member in an acute angle, an obtuse angle or an angle between about 10° to about 75°.

11. The crushing apparatus of claim 8, wherein a cross section of the crushing element includes a first side, a second side and an interior angle between the first side and the second side, and the interior angle is about 30° to about 60°.

12. The crushing apparatus of claim 8, wherein a cross section of the crushing element includes a first side, a second side, a third side, a first interior angle between the first side and the third side, and a second interior angle between the second side and the third side, the second interior angle is substantially smaller than the first interior angle.

13. The crushing apparatus of claim 12, wherein the first interior angle is about 50° to about 60°, the second interior angle is about 30° to about 50°.

14. The crushing apparatus of claim 8, wherein a cross section of the crushing element is in a triangular shape.

15. The crushing apparatus of claim 8, wherein a cross section of the crushing element includes a first side, a second side and a third side, the first side is substantially shorter than the second side or the third side.

16. The crushing apparatus of claim 8, wherein the crushing element includes a surface configured to direct an airflow travelling towards the first outlet, the sieve or the sidewall of the tank.

17. The crushing apparatus of claim 8, wherein the grinder includes a shaft protruded from the bottom surface of the tank and a connecting member connecting the shaft and the crushing element, the connecting member is disposed away from the bottom surface of the tank in a vertical distance of less than about 45 mm.

18. The crushing apparatus of claim 17, wherein the crushing element is tapered from the sidewall of the tank towards the shaft.

19. A crushing apparatus, comprising:
a tank including a first aperture, a sidewall, a second aperture disposed over the sidewall, and a bottom surface;
a first blower disposed around the first aperture; and
a grinder surrounded by the sidewall of the tank and including a shaft protruded from the bottom surface of the tank, a crushing element rotatable about the shaft and configured to grind a material, and a connecting member extending between the shaft and the crushing element,
wherein the crushing element includes a surface extending between the connecting member and the sidewall of the tank, substantially orthogonal to the bottom surface of the tank, and configured to direct the material towards the second aperture.

20. The crushing apparatus of claim 19, wherein the sidewall of the tank includes a roughened portion, the crushing element and the roughened portion of the sidewall are cooperatively operable with each other.
